(19) United States
(12) Patent Application Publication
(10) Pub. No.: US 2009/0057444 A1
(43) Pub. Date: Mar. 5, 2009

(54) Fuel injector

(76) Inventor: Joerg Heyse, Besigheim (DE)

Correspondence Address: KENYON & KENYON LLP, ONE BROADWAY, NEW YORK, NY, 10004, US

(21) Appl. No.: 11/665,095

(22) PCT Filed: Sep. 20, 2005
(86) PCT No.: PCT/EP05/54699

§ 371 Date: Nov. 20, 2008

(30) Foreign Application Priority Data
Oct. 9, 2004 (DE) 10 2004 049 278.6

(51) Int. Cl. B05B 1/26

(52) U.S. Cl. 239/461

(57) ABSTRACT

The fuel injector configured according to the invention is characterized by an orifice plate being situated downstream from a valve-seat body having a fixed valve seat, the orifice plate having at least one outlet opening. Directly upstream from the outlet openings is an inflow opening having an annular inflow cavity. The valve-seat body covers the inflow cavity in such a way that the downstream outlet openings of the orifice plate are covered. The flow-exposed flow-through area above each outlet opening, which is calculated as the product of the circumference of the outlet opening in the region of its entry plane and the free height in the inflow cavity, is smaller than the area of the inflow plane of the outlet opening. The fuel injector is particularly suitable for use in fuel injection systems of the mixture-compressing internal combustion engines having externally supplied ignition.

### FIELD OF THE INVENTION

The present invention is based on a fuel injector according to the definition of the species in the main claim.

### BACKGROUND INFORMATION

Already known from German Patent Publication No. DE 42 21 185 is a fuel injector which has an orifice plate with a plurality of outlet openings downstream from a fixed valve seat. By stamping, the orifice plate is first provided with at least one outlet opening, which extends parallel to the longitudinal valve axis. The orifice plate is then plastically deformed in its mid section where the outlet openings are located, by deep-drawing, so that the outlet openings extend at an incline relative to the longitudinal valve axis and widen frustoconically or conically in the flow direction. In this manner excellent conditioning and good jet stability of the medium discharged through the outlet openings are achieved compared to the fuel injectors known heretofore; nevertheless, the manufacturing process of the orifice plate with its outlet openings is very complex. The outlet openings are provided immediately downstream from an exit opening in the valve-seat body and thus are directly exposed to the flow, the outlet openings themselves defining the narrowest cross section of the flow.

From the printed Japanese Publication No. JP 2001-046919, a fuel injector is already known in which an orifice plate having a plurality of outlet orifices is provided downstream from the valve seat. An inflow opening, which has a larger diameter and forms an annular inflow cavity for the outlet openings, is formed between an outlet opening in the valve-seat body and the orifice plate. The outlet openings of the orifice plate are in direct flow connection with the inflow orifice and the annular inflow cavity and covered by the upper boundary of the inflow orifice. In other words, a complete offset from the outlet opening defining the intake of the inflow opening and the outlet openings is present. The radial offset of the outlet openings from the exit opening in the valve-seat body produces an s-shaped flow pattern of the fuel, which represents an atomization-promoting measure; however, the outlet openings disadvantageously form the narrowest cross section of the flow and lower the atomization quality.

### SUMMARY OF THE INVENTION

The fuel injector according to the present invention has the advantage that a uniform and very fine atomization of the fuel is achieved in a simple manner and that an especially high conditioning and atomization quality with very tiny fuel droplets comes about. This is achieved in an advantageous manner due to the fact that a flow-exposed flow-through area downstream from a valve seat, above at least one outlet opening in an inflow cavity situated upstream from the orifice plate, is smaller than the area of the entry plane of the outlet opening, the flow-through area being calculated as the product from the circumference of the outlet opening in the region of its entry plane and the free height in the inflow cavity. The horizontal velocity components of the flow discharging into the entry plane are not obstructed by the wall of the individual outlet opening at the entry plane, so that the fuel jet has the full intensity of the horizontal components generated in the inflow cavity when leaving the outlet opening and thus fans out with maximum atomization.

In an advantageous manner, an inflow opening is provided in the valve-seat body, upstream from the outlet openings, which has the annular inflow cavity that is larger than an outlet opening downstream from the valve seat. In this way the valve-seat body already assumes the function of a flow controller in the orifice plate. In an especially advantageous manner, resulting from the design of the inflow opening, an s-deflection in the flow is achieved to improve the atomization of the fuel since the valve-seat body covers the outlet openings of the orifice plate by the upper boundary of the inflow opening.

With the aid of galvanic metal deposition, it is advantageously possible to produce orifice plates simultaneously in very large lot numbers in a reproducible, extremely precise as well as inexpensive manner. Moreover, this manufacturing method allows extremely great freedom in design since the contours of the openings in the orifice plate are freely selectable.

### BRIEF DESCRIPTION OF THE DRAWINGS

Exemplary embodiments of the present invention are depicted in simplified fashion in the drawings and explained in greater detail in the description below. The figures show:

FIG. 1a partially illustrated injection valve;

FIG. 2 an enlarged view of the cutaway portion II in FIG. 1 having the annular region configured according to the present invention;

FIG. 3 the same cutaway portion II with a second specific embodiment;

FIG. 4 the same cutaway portion II with a third specific embodiment; and

FIG. 5 the same cutaway portion II with a fourth specific embodiment.

### DETAILED DESCRIPTION

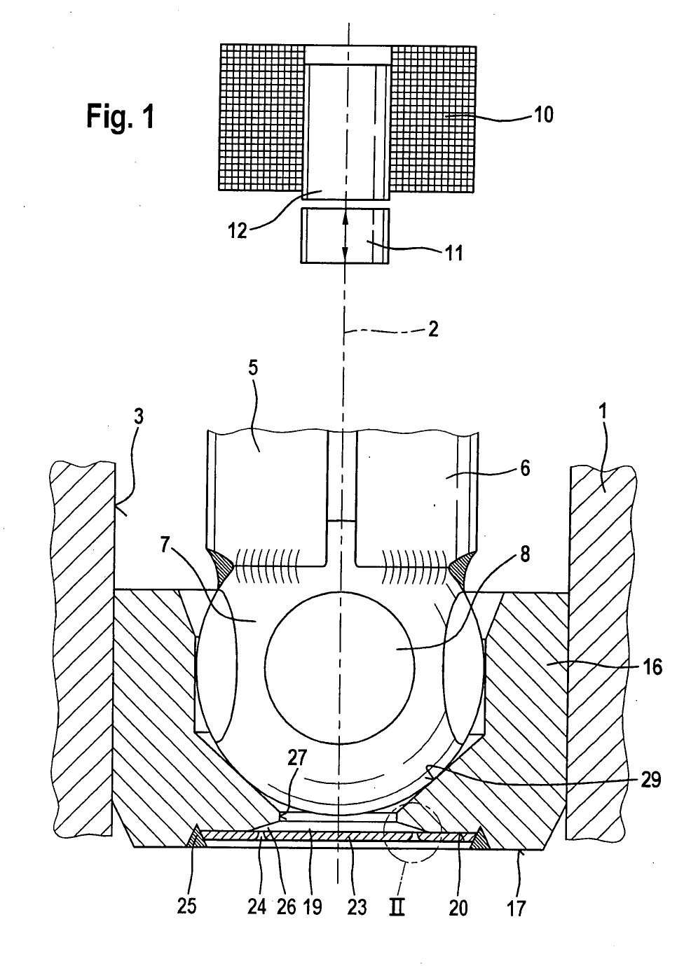

FIG. 1 shows in the form of an exemplary embodiment a partial view of a valve in the form of an injection valve for fuel injection systems of mixture-compressing, externally ignited internal combustion engines. The injection valve has a tubular valve-seat support 1, which is indicated only schematically and forms part of a valve housing, a longitudinal opening 3 being formed in valve-seat support 1 in a concentric manner with respect to a longitudinal valve axis 2. Situated in longitudinal opening 3 is, for example, a tubular valve needle 5, which at its downstream end 6 is securely joined to a spherical valve closure member 7, for instance, at whose periphery five flattened regions 8, for example, are provided for the fuel to flow past.

The fuel injector is actuated in a known manner, e.g. electromagnetically. A schematically sketched electromagnetic circuit, which includes a magnetic coil 10, an armature 11 and a core 12, is used for axial displacement of valve needle 5, and thus for opening the fuel injector against the spring tension of a restoring spring (not shown), or for closing the fuel injector. A welding seam, which is formed by laser, for instance, and which points to core 12, joins armature 11 to the end of valve needle 5 facing away from valve-closure member 7.

With the aid of welding, for instance, a valve-seat body 16 is mounted in the downstream-lying end of valve-seat support 1 so as to form a seal. At its lower front end 17, facing away from valve-closure body 7, valve-seat member 16 has a stepped design, and a recess 20 is provided in a center region about longitudinal valve axis 2 in which a flat, for instance one-layered orifice plate 23 is inserted. Orifice plate 23 has at least one, but ideally two to forty outlet openings 24. Upstream from recess 20 and thus upstream from outlet openings 24 of orifice plate 23, an inflow opening 19 is provided in valve-seat body 16 via which the individual outlet openings 24 are exposed to the flow. Inflow opening 19 has a diameter that is larger than the opening width of an exit opening 27 in valve-seat body 16, from which the fuel flows into inflow opening 19 and ultimately into outlet openings 24.

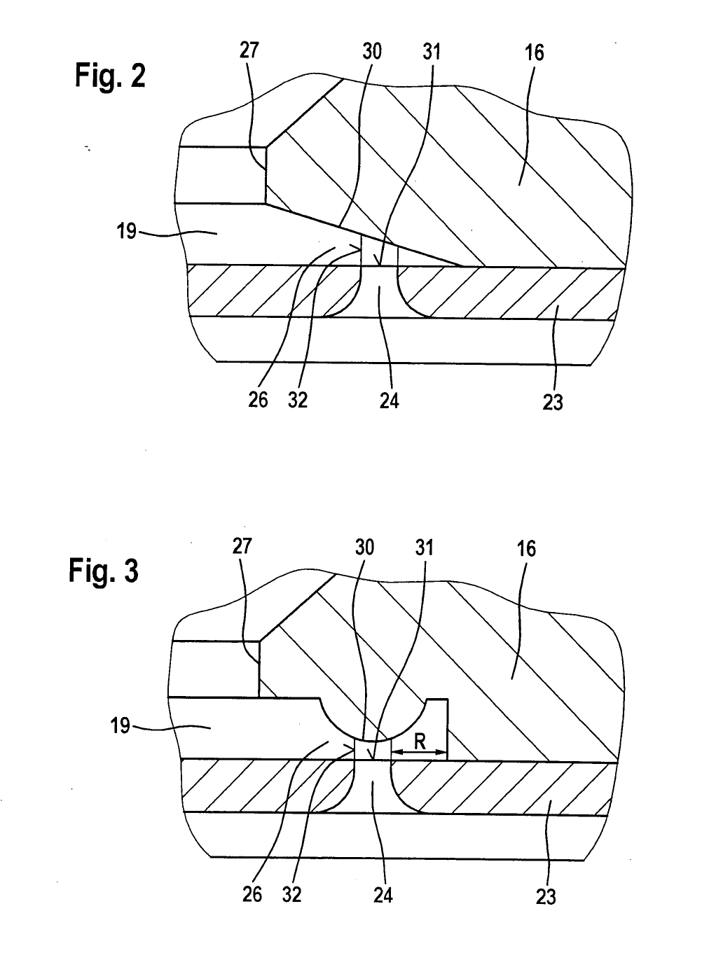

According to the present invention, inflow opening 19 has a special geometry, in particular in the immediate inflow region of outlet openings 24. The annular region of inflow opening 19, which has a larger diameter than exit opening 27, is shown in FIGS. 2 through 5 in an enlarged view, elucidated in greater detail on the basis of these figures, and denoted as inflow cavity 26 in the following text.

The connection of valve-seat body 16 and orifice plate 23 is implemented by, for instance, a circumferential and tight welding seam 25 formed by laser and situated outside of inflow opening 19. After orifice plate 23 has been fixed in place, it is positioned in recess 20 in a recessed manner relative to end face 17.

The insertion depth of valve-seat body 16 with orifice plate 23 in longitudinal opening 3 determines the magnitude of the lift of valve needle 5 since, in a non-energized magnetic coil 10, one end position of valve needle 5 is defined by the seating of valve-closure member 7 on valve-seat surface 29 of valve-seat body 16, which tapers conically in a downstream direction. When solenoid coil 10 is energized, the other end position of valve needle 5 is defined by the seating of armature 11 on core 12, for instance. The path between these two end positions of valve needle 5 therefore constitutes the lift.

As an alternative to the exemplary embodiment shown in FIG. 1, perforated disk 23 may also be made up of, for example, two layers having two functional planes situated on top of one another.

Outlet openings 24 of orifice plate 23 are in direct flow connection with inflow opening 19 and annular inflow cavity 26 and covered by the upper boundary of inflow orifice 19. In other words, a complete offset with respect to exit opening 27, which defines the inlet of inflow opening 19, and outlet openings 24 is present. The radial offset of outlet openings 24 with respect to exit opening 27 brings about an s-shaped flow pattern of the medium, in this case, the fuel.

The so-called s-twist in front of and within orifice plate 23, with several pronounced flow deflections, imparts a strong, atomization-promoting turbulence to the flow. This causes the velocity gradient transversely to the flow to be especially pronounced. It is an indication of the change in the velocity transversely to the flow, the velocity in the center of the flow being markedly greater than in the vicinity of the walls. The higher shear stresses in the fluid resulting from the velocity differences facilitate the disintegration into fine droplets close to outlet openings 24. According to the present invention, the atomization of the fluid is additionally and positively influenced by the specific geometry of inflow cavity 26, so that an even better disintegration into very fine droplets is able to be achieved.

Orifice plate 23 is produced by galvanic metal deposition, for instance; the production of a one-layer orifice plate 23 utilizing lateral overgrowth technology, in particular, is advantageous. Orifice plate 23 may also be produced by stamping. Outlet openings 24 ideally have a trumpet-shaped contour or a contour that resembles a Laval nozzle. The cross section of outlet openings 24 may have a circular, oval or also multi-sided form, for example.

FIG. 2 shows an enlarged cutaway portion II in FIG. 1 to illustrate the geometry of inflow cavity 26 between boundary area 30 of valve-seat body 16 and orifice plate 23. Valve-seat body 16 is configured in such a way that boundary surface 30 steadily slopes from exit opening 27 to orifice plate 23 in a radially outward direction. As a result, only a low height of inflow cavity 26 remains above an entry plane 31 of the at least one outlet opening 24 extending perpendicular to longitudinal valve axis 2, and the flow is continually accelerated on the way to outlet openings 24. According to the present invention, a flow-exposed perpendicular flow-through area 32 above outlet opening 24 in inflow cavity 26, which is calculated as the product of the circumference of outlet opening 24 in the region of its entry plane 31 and the free height in inflow cavity 26, is smaller than the area of entry plane 31 of outlet opening 24 (area 32<area 31). This ratio applies to at least one outlet opening 24; however, the highest atomization quality will be achieved if this ratio is observed for all outlet openings 24 of orifice plate 23.

In the afore-described size ratios, flow-through area 32 is the smallest quantity-metering cross section in the path of the flow. The cross-sectional surface that entry plane 31 of outlet opening 24 offers to the entering flow is larger than required for the flow rate pre-metered via flow-through area 32. This being the case, the flow is completely detached from the wall of outlet opening 24 in entry plane 31. The horizontal velocity components of the flow discharging into entry plane 31 are thus not impeded by the wall of outlet opening 24 at entry plane 31, so that the fuel jet has the full intensity of the horizontal component generated in flow cavity 26 upon leaving outlet opening 24 and thus fans out with maximum atomization.

FIGS. 3 through 5 show three additional inflow cavities 26 configured according to the present invention as annular regions of inflow opening 19, in an enlarged view in a cutaway portion that is comparable to that of FIG. 2 in each case. FIG. 3 shows an exemplary embodiment in which boundary area 30 of valve-seat body 16 curves in a downward direction directly above outlet opening 24 in order to reduce flow-through area 32 to such an extent that it is smaller than the area of entry plane 31 of outlet opening 24.

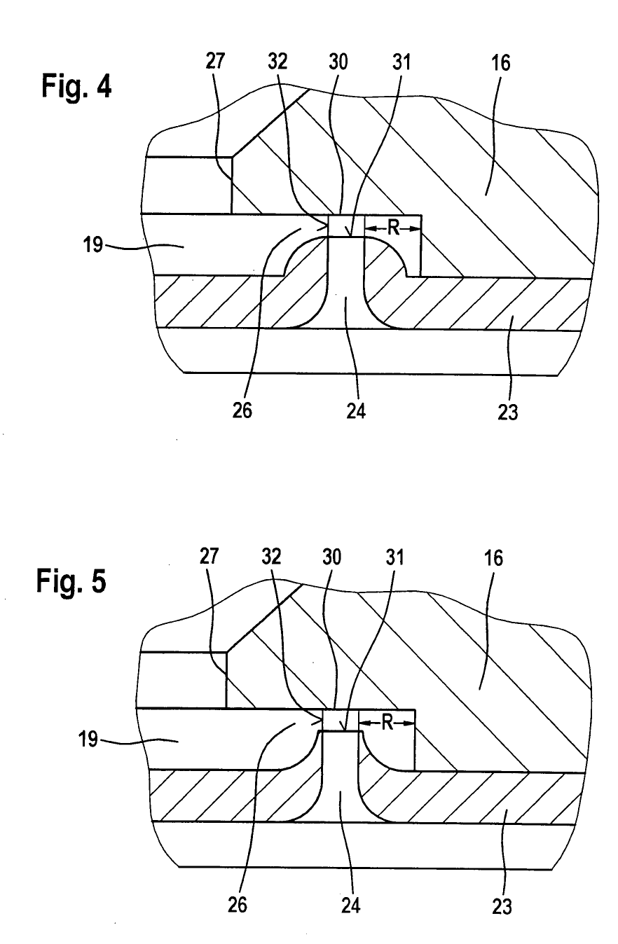

FIGS. 4 and 5 show two exemplary embodiments in which boundary area 30 of valve-seat body 16 is planar and extends perpendicular to longitudinal valve axis 2, but outlet openings 24 have a raised design and extend into inflow cavity 26. The region of perforated disk 23 having a raised design around outlet openings 24 may bulge in a convex manner, for instance (FIG. 4), or in a concave manner (FIG. 5). Such contours are able to be produced by ECM (electrochemical machining) methods, for example. Here, too, it is true that the perpendicular, flow-exposed flow-through area 32 above the at least one outlet opening 24 in inflow cavity 26 is smaller than the area of entry plane 31 of outlet opening 24.

In the examples shown in FIGS. 3 through 5, the height of inflow cavity 26 is reduced only directly in the region of outlet openings 24. In this way, in contrast to the example shown in FIG. 2, the entire region of flow cavity 26 situated around outlet openings 24 offers sufficient height for the flow to flow up to the edges of outlet openings 24 with little loss. Above all, this also supplies the space in the rear of each outlet opening 24 with a considerable portion of the through-flow quantity. Rear space R is understood to denote the region of inflow cavity 26 that lies radially outside of individual outlet opening 24. As a result, the transversal velocity vectors in the outlet of outlet openings 24 are divergent and provide excellent atomization of the fuel.

1-11. (canceled)

12. A fuel injector for a fuel-injection system of an internal combustion engine, comprising:
a valve-seat body having a fixed valve seat;
a valve-closure member that cooperates with the valve seat and is axially displaceable along a longitudinal valve axis;
an orifice plate including at least one outlet opening and situated downstream from the valve seat, wherein a flow-exposed flow-through area above the at least one outlet opening in an inflow cavity provided upstream from the orifice plate, which is calculated as a product of a circumference of the outlet opening in a region of its entry plane and a free height in the inflow cavity, is smaller than an area of the entry of the outlet opening.

13. The fuel injector as recited in claim 12, wherein the inflow cavity is the annular outer region of an inflow opening, which is provided between an exit opening of the valve-seat body and the orifice plate.

14. The fuel injector as recited in claim 13, wherein the inflow opening has a diameter that is greater than the opening width of the exit opening.

15. The fuel injector as recited in claim 11, wherein the inflow cavity is delimited by a boundary area of the valve-seat body lying opposite the at least one outlet opening.

16. The fuel injector as recited in claim 13, wherein a complete offset is present between the exit opening and the at least one outlet opening.

17. The fuel injector as recited in claim 15, wherein the boundary area is inclined at an angle.

18. The fuel injector as recited in claim 15, wherein the boundary area is curved at least in the region of the at least one outlet opening.

19. The fuel injector as recited in claim 12, wherein the at least one outlet opening has a raised design extending into the inflow cavity.

20. The fuel injector as recited in claim 12, wherein the at least one outlet opening has a trumpet-shaped contour or a contour in the shape of a Laval nozzle.

21. The fuel injector as recited in claim 12, wherein the orifice plate is able to be produced with the aid of galvanic metal deposition or stamping technology.

22. The fuel injector as recited in claim 12, wherein between two and forty outlet openings are provided in the orifice plate, and the flow-exposed flow-through area above each outlet opening in the inflow cavity is smaller than the area of the entry plane of the particular outlet opening.
